(19) United States
(12) Patent Application Publication
(10) Pub. No.: US 2010/0139305 A1
(43) Pub. Date: Jun. 10, 2010

(54) ICE MAKING WATER TANK FOR AUTOMATIC ICE MAKING MACHINE

(75) Inventors: Hideji Ota, Tokyoake-shi (JP); Kazuhiro Yoshida, Toyoake-shi (JP); Yuji Wakatsuki, Toyoake-shi (JP); Hiroki Yamaguchi, Toyoake-shi (JP); Yushi Yonekura, Toyoake-shi (JP)

Correspondence Address: Quinn Emanuel Urquhart & Sullivan, LLP, 865 S. FIGUEROA STREET, 10TH FLOOR, LOS ANGELES, CA, 90017, US

(73) Assignee: Hoshizaki Denki Kabushiki Kaisha

(21) Appl. No.: 12/733,098

(22) PCT Filed: Jun. 5, 2008
(86) PCT No.: PCT/JP2008/060391

§ 371 Date: Feb. 9, 2010

(30) Foreign Application Priority Data
Sep. 26, 2007 (JP) 2007-249872

(51) Int. Cl. F25C 1/00; F16K 31/18; E03B 11/00

(52) U.S. Cl. 62/347; 137/409; 137/565.01

(57) ABSTRACT

The object is to provide an ice making water tank for an automatic ice making machine capable of stabilizing the operation of a float switch. As a means for achieving the object, there is provided an overflow portion 64 having a wall portion 58 to define a maximum water storage level of ice making water, and a raised-bottom portion 60 to discharge excess ice making water that has overflowed the wall portion 58 to the outside through a discharge port 62 on a side near the outside of a tank portion 52 of an ice making water tank 32. Furthermore, a partition member 68 is removably disposed on the overflow portion 64 side with respect to the disposed position of the circulation pump 14 in the tank portion 52 to divide the inside of the tank portion 52 into two regions, and to allow ice making water near the bottom portion 56 to flow between the two regions. In addition, a float switch 26 is disposed between the partition member 68 and the overflow portion 64 in the tank portion 52.

### TECHNICAL FIELD

The present invention relates to an ice making water tank for an automatic ice making machine, and more particularly, the present invention relates to an ice making water tank for an automatic ice making machine, which stores ice making water that is supplied through a circulation pump, and collects ice making water that has failed to freeze in an ice making part.

### BACKGROUND ART

As an automatic ice making machine which continuously produces ice, there is known, for example, a flow-down type ice making machine which produces ice by cooling an ice making surface of each ice making plate by a refrigerant supplied to an evaporation tube that is disposed between a pair of ice making plates (see, for example, Patent Document 1). FIG. 3 is a view schematically illustrating an ice making part 18 and an ice making water tank 20 of a conventional flow-down type ice making machine 10. In this flow-down type ice making machine 10, two ice making parts 18 each comprising a pair of ice making plates 12, 12 and an evaporation tube 16 led out from an unillustrated refrigeration system are disposed opposite each other, and an ice making water tank 20 is disposed below the two ice making parts 18, 18.

In the ice making water tank 20, a tank portion 20a for storing ice making water is defined inside thereof, and a suction port 14a of a circulation pump 14, which is disposed in the tank portion 20a, is located near the bottom portion. Between the ice making parts 18, 18 and the ice making water tank 20, there is provided an ice guiding plate 42, which receives ice blocks C that are produced in the ice making parts 18, 18 and fall from the ice making parts 18, 18, and guides them to an unillustrated ice storage. On this ice guiding plate 42, a plurality of recovery holes 42a are provided which recover ice making water that has failed to freeze (unfrozen water) in the ice making parts 18, 18 during ice making operation, back to the ice making water tank 20.

At an region located below the ice making part 18 (ice guiding plate 42) in the tank portion 20a, an overflow tube 22 open at a predetermined height from the bottom portion is disposed separately, and excess water is discharged to the outside of the ice making water tank 20 through the overflow tube 22. A cylindrical cap portion 24 is provided over the overflow tube 22 such that ice making water flows into the cap portion 24 from the gap between the lower end of the cap portion 24 and the bottom portion of the tank portion 20a. That is, the cap portion 24 realizes bottom discharging in which discharge of ice making water near the bottom portion precedes.

The tank portion 20a has a float switch 26 which detects completion of ice making by the water level of ice making water. This float switch 26 has a float 30 which is movable up and down in a cylindrical casing 28 opening downward, and the water level of ice making water in the tank portion 20a can be detected by the position of the float 30.

Patent Document 1: Japanese Laid-open Patent [Kokai] Publication No. Hei 11-148753

### DISCLOSURE OF THE INVENTION

### Problem to be Solved by the Invention

The ice making water stored in the tank portion 20a is in a widely fluctuating state (a wavy state) due to vibrations caused by sucking of the circulation pump 14, dropping of unfrozen water from the ice making parts 18 and so forth in ice making operation. The float 30 is therefore shaken by flowing ice making water, which causes the problem of the operation of the float switch 26 being unstable.

In view of the aforementioned disadvantage inherent in the prior art, the present invention is proposed to overcome it suitably, and it is an object of the present invention to provide an ice making water tank for an automatic ice making machine, capable of stabilizing the operation of the float switch.

### Means for Solving the Problem

In order to solve the aforementioned problem and to achieve the given object, an ice making water tank for an automatic ice making machine according to the present invention, which sucks ice making water that is stored in a tank portion by a circulation pump and provides it to an ice making part at the time of ice making operation, and collects ice making water not frozen to ice in an ice making part into a tank portion comprises:

an overflow portion comprising a wall portion rising from the bottom portion of the tank portion to a predetermined height and defines maximum water storage level of ice making water in the tank portion, and a raised-bottom portion to discharge excess ice making water that has overflowed the wall portion to the outside through a discharge port;

a partition member disposed on the overflow portion side with respect to the disposed position of the circulation pump in the tank portion to divide the inside of the tank portion into two regions, which are a region on the circulation pump side and a region on the overflow portion side, and to allow ice making water near the bottom portion of the tank portion to flow between the two regions; and

a float switch disposed in the tank portion between the partition member and the overflow portion to detect water level in the tank portion.

According to the invention, since a float switch is disposed between a partition member and an overflow portion, it can inhibit fluctuations of ice making water caused by sucking of a circulation pump from being propagated to the float switch side, thereby enabling stabilization of the operation of the switch. Moreover, since the partition member allows flow of ice making water near the bottom portion of the tank portion, the bottom discharging can suitably be achieved.

### Effect of the Invention

According to the ice making water tank for an automatic ice making machine of the present invention, the operation of the float switch can be stabilized.

### BRIEF DESCRIPTION OF THE DRAWINGS

FIG. 1 is a longitudinal sectional view schematically showing an ice making water tank and ice making part according to an embodiment.

FIG. 2 is a schematic plan view of an ice making water tank according to the embodiment.

FIG. 3 is a longitudinal sectional view schematically showing a conventional ice making water tank and ice making part.

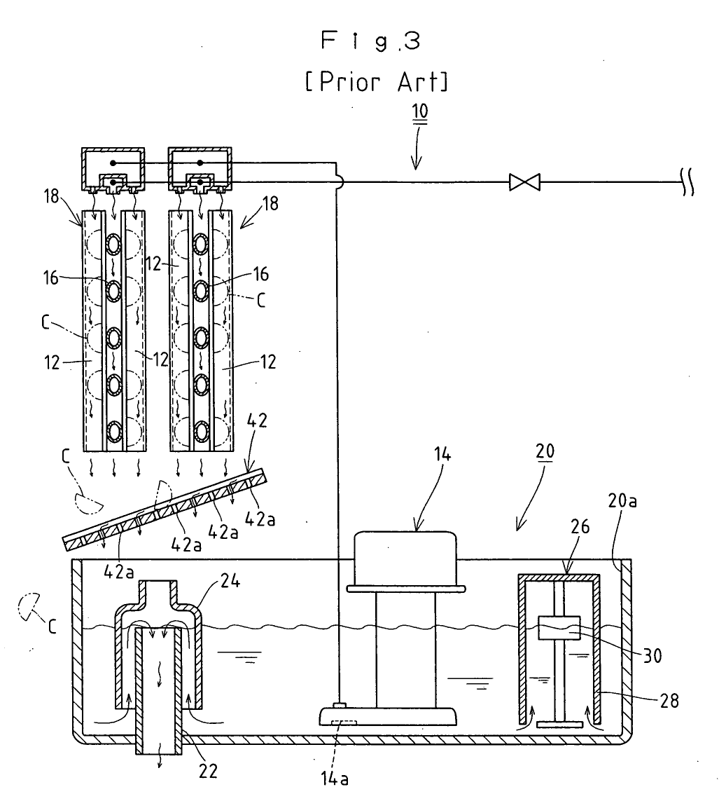

### BEST MODE FOR CARRYING OUT THE INVENTION

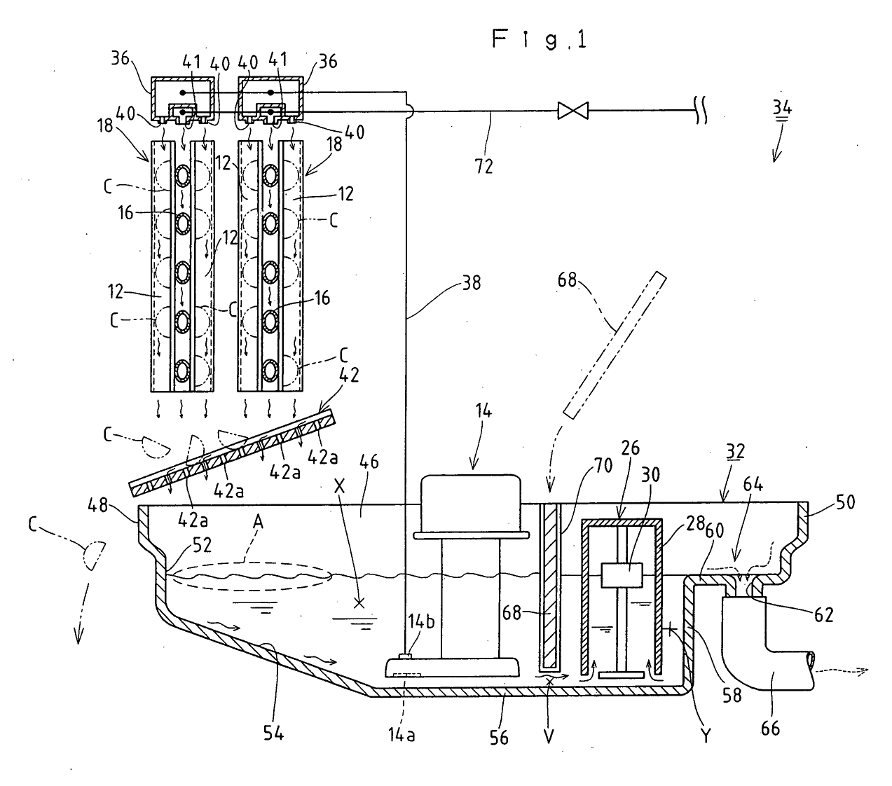

Next, an ice making water tank for an automatic ice making machine according to the present invention will be described below by way of a preferred embodiment referring to the accompanying drawings. In this embodiment, a description will be given using as an example an ice making water tank of a flow-down type ice making machine which produces semicircular ice blocks. The “front”, “rear”, “left”, and “right” in the following descriptions are the terms used when viewing an ice making water tank from the front side as shown in FIG. 1 as a reference.

### Embodiment

FIG. 1 is an explanatory drawing showing a schematic structure of a flow-down type ice making machine 34 comprising an ice making water tank 32 according to an embodiment, and the flow-down type ice making machine 34 has two ice making parts 18 arranged in parallel, each comprising a pair of ice making plates 12, 12. An evaporation tube (evaporator) 16 led out from an unillustrated refrigeration system is disposed between the two ice making plates 12, 12, and a refrigerant is circulatively supplied to the evaporation tube 16 at the time of ice making operation, and a hot gas is circulatively supplied to the evaporation tube 16 at the time of deicing operation. A water spray means 36 is disposed above each ice making part 18, and is configured such that ice making water is provided from ice making water spray holes 40 of the water spray means 36 to the front surfaces of the ice making plates 12, 12 at the time of ice making operation, and water at normal temperature is supplied to the rear surfaces of the ice making plates 12, 12 from a deicing water spray hole 41 of the water spray means 36 at the time of deicing operation. Furthermore, the ice making water spray holes 40 are connected to a later-described outlet 14b of a circulation pump 14 through an ice making water supply tube 38, and the deicing water spray holes 41 are connected to an unillustrated water supply source through a deicing water supply tube 72.

An ice guiding plate 42 for receiving ice blocks C falling from the ice making part 18 in deicing operation, is disposed below the ice making parts 18 to be inclined downward so as to guide the ice blocks C to an unillustrated ice storage. A plurality of recovery holes 42a are open in this ice guiding plate 42 so that water failed to freeze in the ice making parts 18 drops back to the ice making water tank 32 through the recovery holes 42a. Furthermore, in deicing operation, deicing water at normal temperature drops down to the ice making water tank 32 through these recovery holes 42a and stored in the tank 32 for use as ice making water in the next operation.

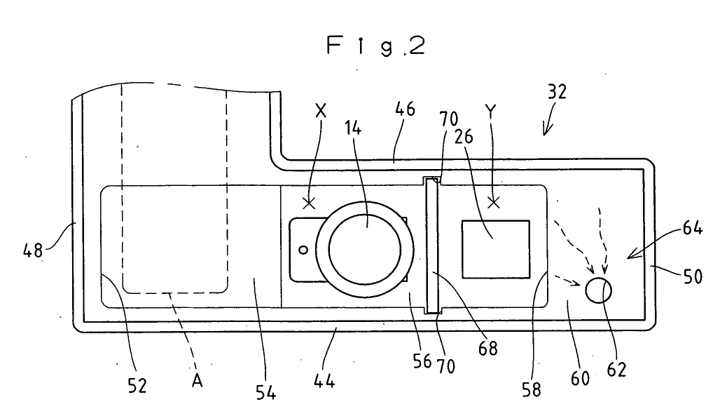

As shown in FIG. 2, the ice making water tank 32 is formed in the form of a tray which is open upward and surrounded in four directions by a front wall 44, a rear wall 46, a left wall 48, and a right wall 50, and a tank portion 52 capable of storing ice making water is defined inside thereof. As shown in FIG. 1; in the embodiment, ice making parts 18 are disposed above the left side of the tank portion 52, so that the aforementioned unfrozen water drops down from above the left side of the tank portion 52. Furthermore, in the descriptions below, the area in the tank portion 52 on which unfrozen water drops is called collection area A.

The bottom portion of the tank portion 52 comprises a horizontal planar portion 56 and an inclined surface 54 sloped downward from the left wall 48 toward the right wall 50 side, and a circulation pump 14 which circulatively supplies ice making water to the ice making part 18 is disposed on the planar portion 56. In this circulation pump 14, a suction port 14a is provided in the bottom portion thereof such that the suction port 14a faces the planar portion 56 at a predetermined distance therefrom. Furthermore, the circulation pump 14 has an outlet 14b, which is in fluid communication with the ice making water supply tube 38, and ice making water sucked at the suction port 14a is discharged to the ice making water supply tube 38 from the outlet 14b. A wall portion 58 rising to a predetermined height is formed on the right side of the tank portion 52 and on the inner side of the right wall 50, and a raised-bottom portion 60 extending from the top of the wall portion 58 toward the outside (the right side) of the tank portion 52 is provided. On this raised-bottom portion 60, a discharge port 62 is open, which discharges to the outside excess water that has overflowed the wall portion 58 out of the ice making water in the tank portion 52. That is, with these wall portion 58, raised-bottom portion 60, and discharge port 62, an overflow portion 64 which performs about the same function as the overflow tube 22 that is described in the section of the prior art, is integrally configured with the ice making water tank 32. The height of the wall portion 58 is set to be lower than the front wall 44 and the like which constitute the outer walls of the ice making water tank 32, and defines maximum water level stored in the ice making water tank 32. An overflow hose 66 is connected in fluid communication with the discharge port 62 so as to discharge excess water to the outside through the overflow hose 66.

As shown in FIG. 2, a thin plate-like partition member 68 is removably installed on the overflow portion 64 side with respect to the circulation pump 14 and collection area A in the tank portion 52 with attachment grooves 70, 70 formed on the front wall 44 and rear wall 46 of the ice making water tank 32. The attachment grooves 70, 70 are respectively formed from the upper edge of the front wall 44 and of the rear wall 46 to a position slightly above the planar portion 56 so that when the partition member 68 is installed in the attachment grooves 70, 70, the lower end of the partition member 68 does not come into contact with the planar portion 56. That is, gap V is defined between the partition member 68 and the planar portion 56 (see FIG. 1).

Furthermore, the upper end of the partition member 68 is in line with the upper ends of the front wall 44 and the rear wall 46 when it is installed in the tank portion 52, and thus it is positioned above maximum water storage level (the upper end of the wall portion 58) of the ice making water. Accordingly, the region inside of the tank portion 52 is divided by the partition member 68 into two regions, which are a region X on the side of the circulation pump 14 (collection area A) and a region Y on the side of the overflow portion 64, and it is also configured such that flow of ice making water between the two regions X and Y is allowed only through the gap V. Therefore, out of the ice making water in the tank portion 52, only the ice making water near the planar portion 56 can flow between the two regions X and Y through the gap V.

A float switch 26 is disposed in the region Y located between the partition member 68 and the overflow portion 64 in the tank portion 52. The float switch 26 comprises a casing 28 which is open downward, and a float 30 which is movable up and down in the casing 28. At the time of ice making operation, the float 30 moves downward, as the stored amount of ice making water gradually decreases, and when ice making water in the tank portion 52 decreased to a water level at which ice making completes, the float 30 detects it and determines completion of ice making.

### Operation of Embodiment

Next, the operation of the embodiment will be described. It should be noted that at an initial state, ice making water in the ice making water tank 32 is assumed to be maximum water storage level (the water level of ice making water being in line with the upper end of the wall portion 58). In ice making operation, a refrigerant is supplied from an unillustrated refrigeration system to the evaporation tube 16 to cool each of the ice making plates 12. Furthermore, the circulation pump 14 is actuated to suck ice making water in the ice making water tank 32 through the suction port 14a. At this time, while ice making water in the tank portion 52 widely fluctuates due to the impulse of the circulation pump 14 at the time of sucking, fluctuation of the ice making water around the float switch 26 is suppressed by the partition member 68.

Ice making water sent to the water spray means 36 by the circulation pump 14 is spray-supplied to the front surface of each ice making plate 12 through the ice making water spray holes 40, exchanges heat with the ice making plates 12, and starts to freeze. Furthermore, water not frozen to ice in the ice making parts 18, 18 falls from the ice making parts 18, 18, is received by the ice guiding plate 42, and is sent back to the ice making water tank 32 through the recovery holes 42a. Although fluctuation (wave) of ice making water occurs in the collection area A when unfrozen water drops into the tank portion 52, fluctuation of ice making water around the float switch 26 is suitably suppressed, as described above, by the partition member 68.

As circulative supply of ice making water proceeds, ice is gradually formed on the ice making plates 12, 12, and accordingly ice making water in the ice making water tank 32 decreases. At this time, the float 30 of the float switch 26 moves downward along with the decrease in ice making water. When ice making operation further proceeds and ice blocks C with a predetermined size are formed in the ice making parts 18, ice making water in the ice making water tank 32 reaches a water level at which ice making completes. Then, the float switch 26 detects it, and ice making operation is terminated. Even at this time, since the fluctuation of ice making water around float switch 26 is suppressed by the partition member 68, there is no misdetection by the float switch 26, which ensures detection at the right time of ice making completion.

When ice making operation shifts to deicing operation, while deicing water (water at normal temperature) is supplied to the space between the ice making plates 12, 12 through a deicing water spray hole 41 of the water spray means 36, hot gas is supplied to the evaporation tube 16 from an unillustrated refrigeration system. Ice blocks C formed on the respective ice making parts 18 start to fall as the frozen surfaces with the ice making plates 12, 12 melt due to the supply of hot gas and deicing water. The ice falling from the ice making parts 18 is received by the ice guiding plate 42 and guided to an unillustrated ice storage by the ice guiding plate 42. Furthermore, deicing water supplied to the space between the ice making plates 12, 12 drops through the recovery holes 42a of the ice guiding plate 42 down to the ice making water tank 32 and stored therein. Then, deicing water flowed into the tank portion 52 is spread over the entire tank portion 52 through gap V between the partition member 68 and the planar portion 56. Accordingly the water level in the tank portion 52 rises, and the float 30 moves upward. Even in this case, while fluctuation of ice making water occurs in the collection area A due to the drop of deicing water, the fluctuation of ice making water around float switch 26 is suppressed by the partition member 68.

When deicing operation further proceeds and ice making water in the tank portion 52 reaches maximum water storage level, excess ice making water flows over the wall portion 58 into the overflow portion 64 side. Then, excess ice making water flows into the overflow hose 66 through the discharge port 62 of the raised-bottom portion 60 to be discharged to the outside of the ice making water tank 32. Here, regarding ice making water (excess water) on the circulation pump 14 side, since ice making water near the planar portion 56 gradually flows into the overflow portion 64 side through gap V, the bottom discharging of ice making water is suitably achieved.

As explained above, according to the ice making water tank 32 of the embodiment, since the overflow portion 64 is integrally provided on a side of the tank portion 52, there is no need to separately provide an overflow tube 22 as conventional ones, and thus the production cost can be lowered. Furthermore, since the partition member 68 is located between the collection area A and the float switch 26 in the embodiment, fluctuation of ice making water which occurs when ice making water and deicing water drop down to the ice making water tank 32 can be suppressed around the float switch 26.

It should be noted that while the embodiment has the structure that the partition member 68 is removably installed in the ice making water tank 32 by the attachment grooves 70, 70, the partition member 68 may be integrally formed in the tank portion 52. Furthermore, the embodiment has the structure that gap V is provided between the partition member 68 and the planar portion 56 of the tank portion 52 such that ice making water flows through the gap V. It is possible, however, to have the structure that, an opening is formed, for example, on the lower portion side of the partition member 68 such that ice making water flows through the opening, as long as the structure allows a flow of ice making water near the bottom portion.

While the descriptions in the embodiment are given using as an example an ice making water tank 32 provided in a flow-down type ice making machine 34, the ice making water tank 32 according to the present invention can suitably be employed in the other types of ice making machines such as a water jet-type ice making machine so long as ice making water is circulatively supplied.

1. An ice making water tank for an automatic ice making machine which sucks ice making water stored in a tank portion (52) by a circulation pump (14) and provides the ice making water to an ice making part (18), and collects ice making water not frozen to ice in the ice making part (18) into the tank portion (52) in ice making operation, comprising:
an overflow portion (64) having a wall portion (58) rising from the bottom portion (56) of the tank portion (52) to a predetermined height to define maximum water storage level of ice making water in the tank portion (52), and a raised-bottom portion (60) to discharge excess ice making water that has overflowed the wall portion (58) to the outside through a discharge port (62);
a partition member (68) disposed in the tank portion (52) on the overflow portion (64) side with respect to a disposed position of the circulation pump (14) to divide inside of the tank portion (52) into two regions, which are a region (X) on the circulation pump (14) side and a region (Y) on the overflow portion (64) side, and to allow ice making water near the bottom portion (56) of the tank portion (52) to flow between the two regions (X, Y); and
a float switch (26) disposed between the partition member (68) and the overflow portion (64) in the tank portion (52) to detect water level in the tank portion (52).

2. The ice making water tank for an automatic ice making machine according to claim 1, wherein a collection area (A) to collect into the tank portion (52) ice making water not frozen to ice in the ice making part (18) is disposed on the circulation pump (14) side with respect to the partition member (68) in the tank portion (52).
